(19) United States
(12) Patent Application Publication
(10) Pub. No.: US 2014/0222830 A1
(43) Pub. Date: Aug. 7, 2014

(54) SELECTING CONTENT FOR A USER

(71) Applicant: RHAPSODY INTERNATIONAL INC., Seattle, WA (US)

(72) Inventors: Brian Ringer, Seattle, WA (US); Xiangwei Li, Redmond, WA (US)

(73) Assignee: RHAPSODY INTERNATIONAL INC., Seattle, WA (US)

(21) Appl. No.: 13/758,538

(22) Filed: Feb. 4, 2013

(51) Int. Cl. G06F 17/30

(52) U.S. Cl. CPC G06F 17/30424
USPC 707/748; 707/758

(57) ABSTRACT

Systems and methods for selecting content for a user. A computer system may received from a user device associated with the user a request for a content search and a first search factor describing motion of the user. The computer system may also receive a second search factor describing an environment of the user. The computer system may select at least one content item to be provided to the user based on at least the first search factor and the second search factor; and transmit an indication of the at least one content item towards the user device.

### BACKGROUND

This application generally relates to selecting content items, such as audio content items, for a user.

A proliferation of content provider services gives users access to all types of digital content including, music, movies, books, etc. Typically, a content provider service obtains license rights to a library of digital content. A user subscribes to the content provider service to receive content items, either individually or bundled together (e.g., by genre). via a stream. Users receive the content items via various different types of user devices including, for example, mobile devices, other computers, network-enabled stereo receivers, etc. Users are charged according to many different types of payment methodologies including, for example, periodic subscription charges, charges by content item, charges by unit time, etc. Traditional search engines and similar tools allow users to search libraries of available content to find content items for viewing, listening and/or downloading.

### DRAWINGS

Various example embodiments are described herein by way of example in conjunction with the following figures, wherein:

FIG. 1 is a block diagram showing one example embodiment of an environment for implementing systems and methods for selecting content for users.

FIG. 2 is a block diagram showing one example embodiment of a playback system in communication with a user device and a content distribution system.

FIG. 3 is a block diagram showing another example embodiment of a playback system implemented as part of a combined content system.

FIG. 4 is a flow chart showing one example embodiment of a process flow for selecting content for a user.

FIG. 5 is a flow chart illustrating one embodiment of a process flow that may be executed by a content provider service to select content items in a staged search.

FIG. 6 is flow chart illustrating one embodiment of a process flow that may be executed by a content provider service to select content items utilizing a weighted sum of scores.

### DESCRIPTION

Various example embodiments described herein are directed to systems and methods for selecting content for a user. Content selection may be based on one or more search factors describing the user, the user's environment, the time of the search, etc. as well as one or more characteristics of the content items themselves. In some example embodiments, the search factors include one or more search factors describing motion of the user (e.g., a tempo of the user's motion, a type of the user's activity), one or more search factors describing an environment of the user (e.g., a geographic location, weather conditions, events at the geographic location), and/or one or more temporal search factors describing a timing of the request (e.g., a time of day, a day of the week, etc.). Content selection as described herein may be implemented in the context of a content provider service. A content provider service distributes content items (e.g., digital content items) to users. The content items may include any type of content (e.g., digital content) that may be provided to user devices. For example, the content items may include audio, video and/or textual content embodying any type of programming including, for example, songs, videos of any sort, books, periodicals, etc.

The content provider service may receive, from a user device associated with a user, a request for a content search as well as one or more search factors. Search factors may include, for example, a tempo of the user's motion, an intensity of the user's motion, user preferences and/or content filters, a history of content items previously provided to the user, weather conditions at the user's geographic location, etc. The search factors may be correlated to one or more content item characteristics. Example content item characteristics include tempo, mood, mode, loudness, etc. Tempo may indicate an audio and/or spatial frequency associated with a content item. In the context of a song or other content item comprising audio, tempo may indicate a frequency of the audio. Mood may indicate a mood associated with the content item such as, for example, happy, angry, sad, relaxing, etc. Mode may apply to audio content items, such as songs, and/or to content items that have an audio component. Mode may indicate, for example, whether the content item is in a minor or major key. Loudness, for example, may indicate an audio volume associated with the content item.

In various embodiments, each search factor may be related by the service provider system to one or more content item characteristics. For example, a user's motion tempo may correspond to content item tempos. Weather conditions at the user's location may correspond to different content item moods, modes, loudnesses or combinations thereof. Various geographic areas or locations may correspond to different content item moods, modes, loudnesses or combinations thereof. Various user preferences (e.g., genres, playlists, blocked content items, etc.) may be applied in a binary manner. For example, a content item may either meet a user preference or fail to meet it. The search factors and corresponding content item characteristics provided here are merely examples. It will be appreciated that any suitable factors and characteristics may be utilized.

The content provider service may utilize search factors and content item characteristics to identify at least one content item for the user in any suitable manner. In some embodiments, the content provider service implements a staged search. At a first stage, a first search factor may be compared to its corresponding content item characteristic for a plurality of content items. The result of the first stage may be a first set of content items having a corresponding content item characteristic that either meets or is within a threshold of the first search factor. For example, when the first search factor is a tempo of the user's motion, the first set of content items may comprise content items having tempos within a threshold of the provided tempo (e.g., ±5%). Also, for example, when the first search factor is a preferred genre, the first set of content items may comprise content items in the preferred genre. At a second stage, a second search factor may be compared to its corresponding content item characteristic for the content items making up the first set. Content items from the first set having a corresponding characteristic that either meets or is within a threshold of the second search factor may make up a second set of content items. Additional stages may be applied to further winnow the second set of content items.

In some embodiments, the content provider service may apply a model based on multiple search factors and corresponding content items' characteristics. For example, each search factor may be given a weight. Each content item under consideration may be assigned a score, where the score indicates a weighted sum of correlations between the search factors and their corresponding content item characteristics. The search may return content items with the highest scores, content items having scores above a given threshold, etc. In some embodiments, the content service provider may modify subsequent content item searches, for example, based on user feedback. Modifications may include, for example, changing the weighting of a particular search factor, changing the ordering of stages, etc.

Reference will now be made in detail to several embodiments, examples of which are illustrated in the accompanying figures. Wherever practicable similar or like reference numbers may be used in the figures and may indicate similar or like functionality. The figures depict example embodiments of the disclosed systems (or methods) for purposes of illustration only. One skilled in the art will readily recognize from the following description that alternative example embodiments of the structures and methods illustrated herein may be employed without departing from the principles described herein.

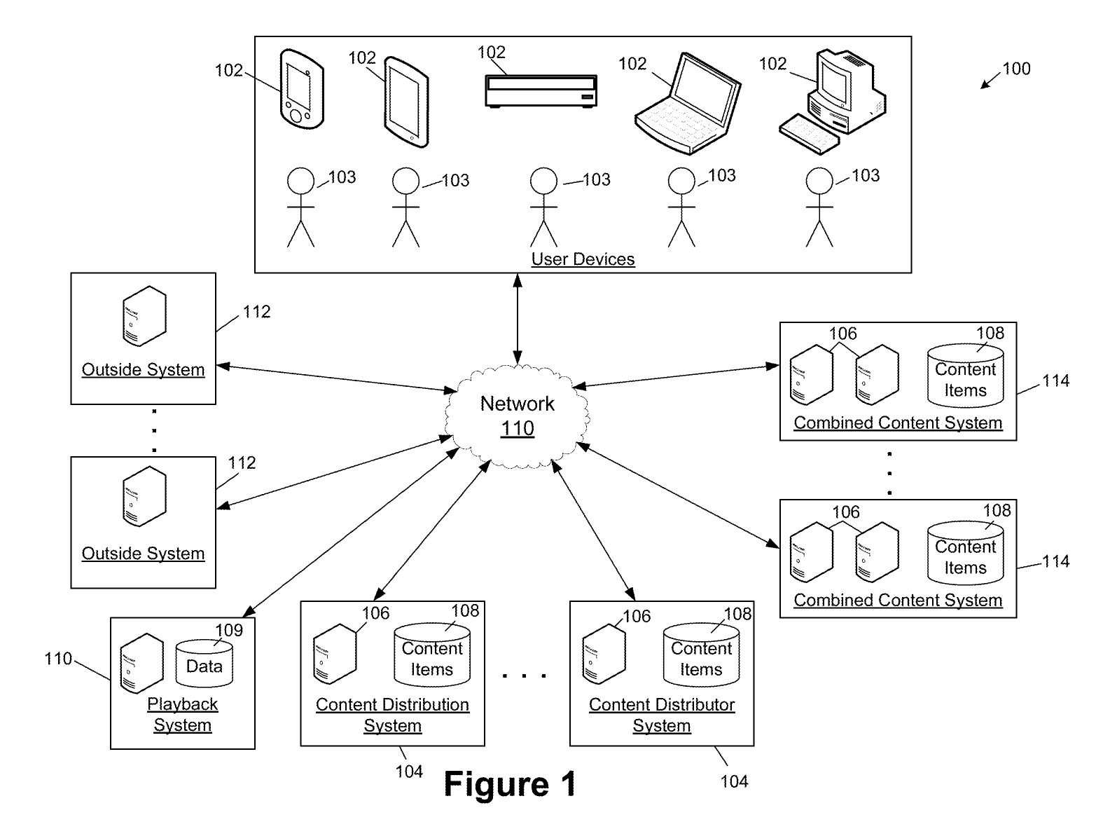

FIG. 1 is a block diagram showing one example embodiment of an environment 100 for implementing systems and methods for selecting content for a user. The environment 100 comprises one or more content distribution systems 104, one or more playback systems 110, one or more outside systems 112, and a plurality of user devices 102. Each user device 102 may be associated with a user 103. For example, a user 103 may own, lease, or otherwise have rights to use his or her associated user device 102. The user devices 102 may receive various content items and/or user interfaces from and/or through other systems 104, 110, 112, 114 of the environment 100 and provide the content items to the associated user 103, for example, as described herein. User devices 102 may comprise any type of network-enabled computer device that may be utilized by a user to receive and/or view content items. Examples of user devices include smart phones, tablet computers, laptop computers, desktop computers, network-enabled stereo receivers, etc. Some user devices 102 comprise functionality for executing an app for providing the user 103 with access to the functionality for selecting content, as described herein. Some user devices 102 also comprise sensors or other hardware for capturing and reporting factors describing the user 103 such as, for example, the user's movement tempo, the user's geographic location, etc. In some example embodiments, each user 103 is associated with a subscription account to one or more content provider services. It will be appreciated, however, that subscription accounts may be associated with user devices 102 in addition or instead of being associated with users 103.

Content provider services may be embodied by one or more playback systems 110, which may operate in conjunction with one or more content distribution systems 104. A playback system 110 may receive a request for a content item from a user 103. In response to such a request, the playback system 110 may authenticate the user 103 and/or associated user device 102 to determine that the user 103 and/or the user device 102 has an active subscription that entitles the user 103 (and/or device 102) to access requested content items. Provided that the authentication is successful, the playback system 110 may cause the requested content item to be transmitted to a user device 102 associated with the requesting user 103. For example, the playback system 110 may request that the content item be transmitted to the user device 102 by a content distribution system 104. Content items may be transmitted from a content distribution system 104 to a user device 102 in any suitable manner. For example, the content items may be transmitted via a secure communication channel formed between the content distribution system 104 and the user device 102 such a transport layer security (TLS) or secure socket layer (SSL) channel. Also, for example, some content items may be individually encrypted during communication or transmitted in the clear. It will also be appreciated that content items may be provided to user devices 102 as discrete files or units or as part of a stream of content.

The playback system 110 may be programmed to implement various tools allowing users 103 to search available content items including content item selection described in more detail below. In addition, or instead, playback systems 110 may provide search engines, play lists and/or radio stations. Search engines may allow users 103 to locate content items according to any suitable searching methodology such as, for example, key word searches, searches by genre, searches by content item type, etc. Play lists may be lists of content items, for example, stored at playback systems 110. A play list may be created automatically, created by editorial staff of the content service provider, and/or based on input from a user device 102. Play lists may be available to all users 103, only to originating users 103, to select users 103, etc. A radio station may comprise a flow of content items generated, for example, by a playback system 110 and, for example, streamed to one or more users. The content items making up a radio station flow may be repeated and/or continuously updated (e.g., by a playback system 110). Specific content items may be included in a radio station flow may be selected based on one or more common characteristics (e.g., similarity to a set of user selected content items, a common genre, a common artist, a common theme, etc.). In some embodiments, the playback system 110 comprises a data store 109 that includes some or all of the content items that may be provided to users 103. For example, in some embodiments, the playback system 110 partially or completely provides the content items directly to the users 103 thus replacing some or all of the functionality of the content distribution systems 104.

Some content provider services utilizes content distribution systems 104. Content distribution systems 104 may comprise one or more data stores 108 comprising content items and a server or other computer device 106 for processing requests. In various example embodiments, the content server system 110 may utilize multiple distributed content distribution systems 104, as shown. Some or all of the content distribution systems 104 may be mirrors of one another located at disparate geographic and/or network locations. For example, the playback system 110 may balance the loads of various content distribution systems 104 by directing requests to transmit content items to different content distribution systems 104 based on geographic and/or network proximity between the requesting user device 102 and the various content distribution systems 104, loads on the content distribution systems 104, etc. In some embodiments, the content distribution systems 104 may be operated by a third-party vendor of the content provider service.

In some example embodiments, some or all of the functionality for implementing a content provider service may be consolidated in one or more combined content systems 114. A combined content system 114 may comprise one or more servers or other computer devices 106 as well as one or more data stores 108 of content items to be provided to user devices 102. The various devices 106 and data stores 108 of the combined content system 114 may be at a common geographic location and/or distributed across more than one geographic location. The combined content system 114 may be programmed to implement the functionality of the playback system 110 and the content distribution system 104 described herein above. A content provider service may implement a single combined content system 114 and/or may operate distributed mirror combined content systems 114, for example, to allow load balancing based on the geographic or network location of requesting user devices 102, the load on various systems 114, etc.

In various embodiments, the environment 100 also comprises one or more outside systems 112. For example, the playback system 110 and/or combined system 114 may receive various search factors from the outside system. For example, when a search factor is or implicates the weather at the user's location, the playback system 110 may receive the user's location from an associated user device 102 and may receive the weather conditions at that location from an outside system 112, such as a weather service server. Outside systems 112 may also provide, for example, various other data describing content items, users and/or search factors. The various components 102, 104, 110, 112, 114, 116 of the environment 100 may communicate with one another via a network 116. The network 116 may be any suitable type of wired, wireless, or mixed network and may comprise, for example, the Internet, a local area network (LAN), a wide area network (WAN), etc.

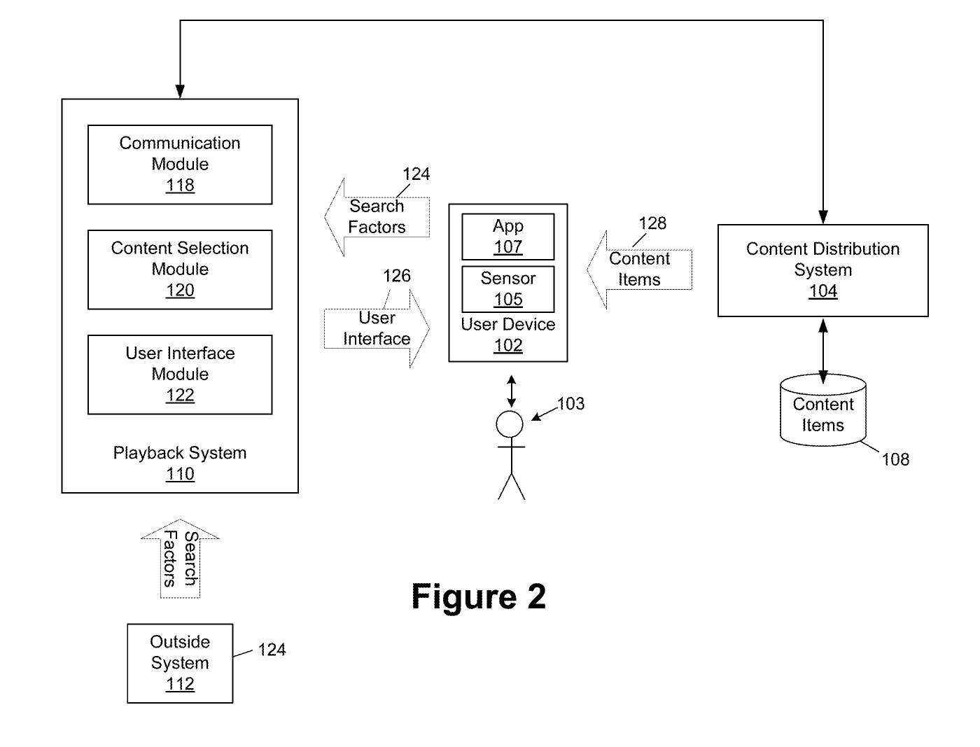

FIG. 2 is a block diagram showing one example embodiment of a playback system 110 in communication with a user device 102 and a content distribution system 104. The content distribution system 104 may provide content items 128 to the user device 102, for example, as described herein. The playback system 112 comprises a communication module 118, a content selection module 120 and a user interface module 122. The communication module 118 may be programmed to facilitate communication between the playback system 110 and various other components of a content provider service such as, for example, the content distribution system 104, a playback system 110, etc. For example, when the content selection module 120 identifies one or more content items 128 to the user device 102 (e.g., via the user interface 126). Also, in various embodiments, the playback system 110 may initiate the provision of one or more content items 128 to a user 103, for example, by instructing at least one of the content distribution systems 104 to provide the content item or items 128 to the user device 102. The content selection module 120 may be programmed to select content for users 103, for example, based on search factors and content item characteristics, as described herein. The user interface module 122 may be programmed to generate a user interface 126 and provide the interface 126 to users 103 (e.g., via the associated user devices 102). The interface 126 may provide the users 103 with indications of selected content items, as described herein.

The example user device 102 shown in FIG. 2 comprises an application, or app, 107 and at least one sensor 105. The app 107 may be executed by the user device 102 to facilitate the content selection functionality of the playback system 110 described herein. The app 107 may be programmed to receive and/or derive various search factors 124 that may be, in turn, provided to the playback system 110. For example, the at least one sensor 105, e.g., at the direction of the app 107, may be configured to derive various additional factors relating to the user 103 (e.g., environment factors, temporal factors such as day, time, time of year, etc.). In some embodiments, the at least one sensor 105 comprises an accelerometer or similar sensor for measuring motion of the user device 102. For example, when the user device 102 is a mobile device, the user 103 may carry the user device 102 with him or her. Therefore, motion of the user device 102 may approximate motion of the user 103. The type of user motion measured by the at least one sensor 105 may be of any suitable type. For example, the at least one sensor 105 may measure a frequency or tempo of motion. When the user 103 is jogging, for example, the frequency or tempo of motion may correspond, for example, to the frequency or tempo of the user's steps. In some embodiments, the at least one sensor 105 measures an intensity of the user's motion. For example, if the user 103 is using a punching bag, the intensity of the user's motion may indicate the force with which the user 103 is striking the bag. The at least one sensor 105, in some embodiments, also comprises a sensor for measuring one or more physiological properties of the user 103 including, for example, heart rate, respiration rate, etc.

In some embodiments, the at least one sensor 105 may comprise a sensor and/or functionality for determining a geographic location of the user 103 (e.g., of the user device). For example, the user device 102 may comprise a global positioning system (GPS) and/or may utilize other functionality to determine its geographic location. In some embodiments, the playback system 110 may determine the position of the user device 102, for example, based on the content distribution system 104 that is selected to provide content items 128 to the user 103. FIG. 2 also illustrates an outside system 112 that may provide additional search factors 124. For example, when the user device 102 provides an indication of its geographic location, the playback system 110 may receive an indication of weather conditions at the geographic location from an outside system 112.

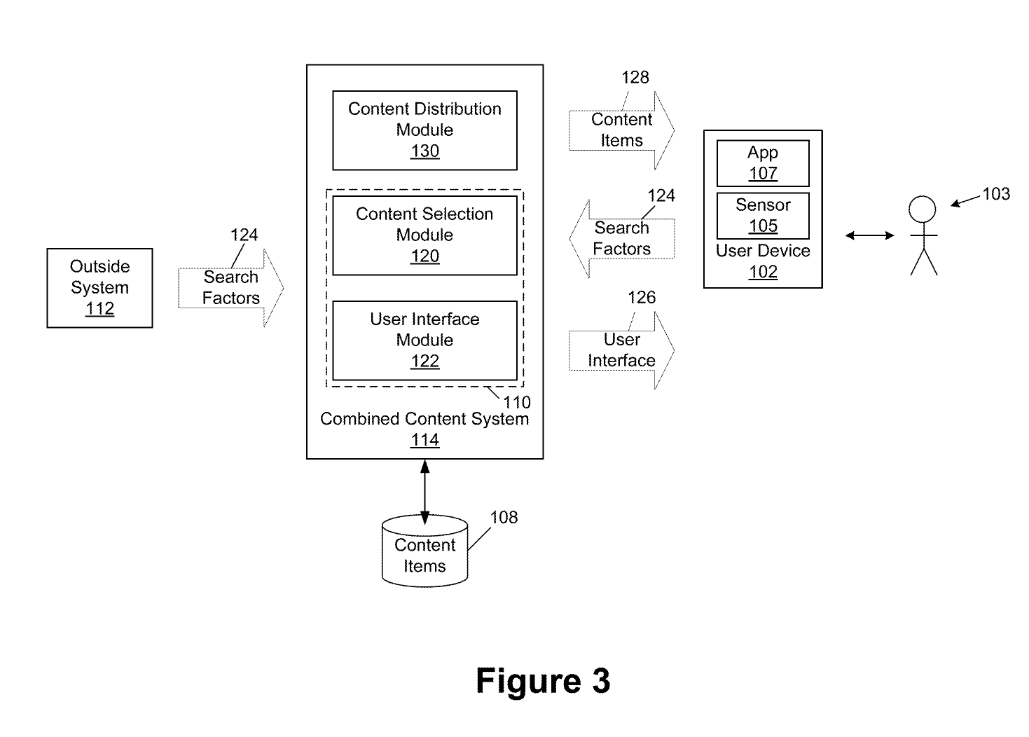

FIG. 3 is a block diagram showing another example embodiment of the described search functionality implemented as part of a combined content system 114. The combined content system 114 is in communication with one or more data stores 108 comprising content items to be provided to users 103. The combined content system 114 comprises a content distribution module 130 that may be programmed to provide content items 128 to users 103 in a manner similar to that of the content distribution system 104 described herein. The combined content system 114 may also comprise a content selection module 120 and user interface module 122 similar to those described herein with respect to the playback system 110.

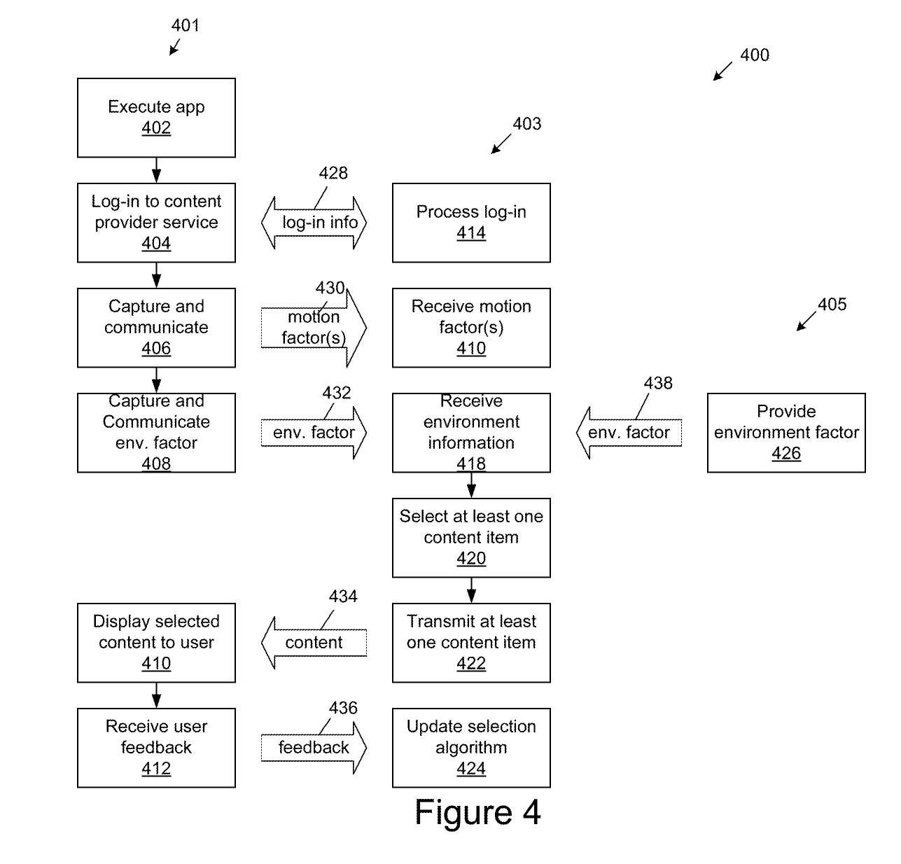

FIG. 4 is a flow chart showing one example embodiment of a process flow 400 for selecting content for a user. The process flow 400 may be executed by various components of the environment 100 of FIG. 1. For example, the process flow 400 comprises three columns 401, 403, 405. Column 401 comprises actions that may be performed by a user device 102 associated with a user 103. The column 403 comprises actions that may be performed by a content provider service. Although the actions of the column are described herein as being performed by the playback system 110, it will be appreciated that some or all of the actions of column 403 may be performed by various other components of a content provider service, such as, for example, a combined content system 114. Column 405 comprises actions that may be performed by an outside system 112.

At 402, the user device 102 may execute a content selection app, such as the app 107. At 404, the user device 102 may log-in to a content provider service, for example, by providing log-in information 428 to the playback system 110. The playback system 110 processes the log-in information at 414. In some embodiments, the playback system 110 may request additional information from the user device 102 to complete the log-in, as indicated by the indication of log-in information as a double-sided arrow 428. At the completion of log-in, content selection may be initiated by any suitable party in any suitable manner. In some embodiments, the user 103 requests content selection via the app 107, with the request transmitted to the playback system 110. In some embodiments, the playback system 110 may select content for the user 103 automatically, for example, upon the user's log-in.

Upon the initiation of content selection, the user device 102 may capture and provide at least one user motion factor 430 to the playback system 110. The user motion factor may be any factor describing motion of the user 103 (e.g., as captured by an accelerometer or other suitable sensor at the user device 102). For example, the user motion factor may be a tempo of the user's motion, an intensity of the user's motion, etc. The playback system 110 may receive the motion factor 430 at 410. In some embodiments, the user device 102 may provide a raw sensor signal to the playback system 110. For example, the playback system 110 may, at 410, derive from the raw sensor signal an indication of the user's motion tempo, the user's motion intensity, etc.

At 408, the user device 102 may capture and communicate at least one environment factor 432 to the playback system 110. The playback system 110 may receive the environment factor 432 at 418. The environment factor 432 may be any factor describing an environment of the user 103 (for example, as indicated by the environment and/or the location of the user device 102). One type of environment factor may be the geographic location of the user 103. Another type of environment factor may be, for example, a weather condition and/or current event taking place at the geographic location. In some embodiments, environment factors may also be received by the playback system 110 from an outside system 112. For example, the playback system 110 may request and receive from an outside system 112 additional information about the location as one or more outside environment factors 438. The additional information about the user's location may include, for example, a current or projected weather condition of the location, historical facts about the location, a description of the climate at the location, points of interest at or near the location, etc. In addition to or instead of the environment factor 432, the playback system 110 may consider a temporal factor describing the user 103 such as, for example, a time of day, a time of year, a day of the week, etc. Such factors may be received, for example, from an outside system 112 and/or from a system clock and/or calendar of the playback system 110 and/or user device 102.

At 420, the playback system 110 may select at least one content item in view of the motion factor 430 and the at least one environment factor 432, 438. The at least one content item may be selected in any suitable manner, as described herein. For example, the playback system 110 may compare each search factor to at least one corresponding content item for each of a plurality of content items. Content items may be selected from the plurality of content items based on the correlation (or lack of correlation) between search factors and corresponding content item characteristics. At 422, the playback system 110 may transmit an indication of the selected content 434 to the user device 102, which may display the selected content 434 to the user 103 at 410. The selected content may be displayed, for example, as a list of one or more content items. In some embodiments, in addition to or instead of sending and displaying a list of content, the playback system 110 may cause the provisioning of the content items to the user device 102. For example, the playback system 110 (e.g., a communication module 118 thereof) may request that a suitable content distribution system 104 provide the selected content items to the user device 102 for playback to the user 103. Optionally, the user device 102, at 412, may receive feedback from the user 103. The feedback may indicate, for example, whether the selected content was acceptable to the user. The feedback 436 may be provided to the playback system 110. The playback system 110 may, at 436, update its content selection algorithm for the user 103 in response to the feedback 436.

The selection of the at least one content item at 420 may be performed in any suitable manner. In some embodiments, the playback system 110 (e.g., the content selection module 120 thereof) may have access to a library comprising a plurality of content items. The playback system 110 may apply the received search factors to attributes of each of the content items and select one or more content items based on a degree of matching or correlation between the search factors and the corresponding content item characteristics. It will be appreciated that more or fewer factors than are shown in FIG. 4 may be used. For example, Table 1 below provides a list of search factors and corresponding content item characteristics:

TABLE 1

| | Corresponding | |
|---|---|---|
| | Content Item | |
| Search Factor | Characteristic(s) | Correlation |
| User motion tempo | Content item tempo | In various embodiments, the playback system 110 |
| | | is more likely to select content items having a |
| | | content item tempo that is about equal to or |
| | | within a threshold of the user motion tempo. |
| User motion | Content item loudness | In various embodiments, the playback system 110 |
| intensity | | is more likely to select content items having a |
| | | loudness that is correlated to the user motion |
| | | intensity (e.g., more intense motion may bias the |
| | | system 110 to select louder content items). |
| User physiological | Content item tempo | In various embodiments, the playback system 110 |
| activity level (e.g., | | is more likely to select content items having a |
| heart rate, | | tempo that correlates to the user's heart rate or |
| respiration rate, | | other indicator of physiological activity. |
| etc.) | | |
| User's change in | Content item tempo | In various embodiments, the playback system 110 |
| tempo and/or | and/or mood | is more likely to select content items that |
| physiological | | correlate to a change in the user's tempo or |
| activity level | | physiological activity level. For example, when |
| | | the user's tempo and/or physiological activity |
| | | level increases, an up-tempo and/or happy |
| | | content item may be selected. When the user's |
| | | tempo and/or physiological activity level |
| | | decreases, such as during a cool-down, lower |
| | | tempo and/or inspirational content items may be |
| | | selected. |
| User geographic | Mood, mode, | In various embodiments, the playback system 110 |
| location | loudness, and/or genre | is more likely to select content items having a |
| | | mood, mode, and/or loudness that corresponds to |
| | | physical, man-made, and/or historical point of |
| | | interest at or near the user's geographic location. |
| | | For example, peaceful, quiet, and/or major key |
| | | content items may be selected near an |
| | | inspirational nature site such as, for example, a |
| | | stream, a mountain view, etc. or near a memorial |
| | | site, such as a war memorial. Also, for example, |
| | | up-beat patriotic content items may be played at |
| | | or near a famous historical location. |
| User's geographic | User's listening | In various embodiments, the playback system 110 |
| location | history | is more likely to select a content item if the user |
| | | 103 or a similarly situated user 103 has received |
| | | the same content item at or near the user's |
| | | location. |
| Current weather at | Content item mood, | In various embodiments, the playback system 110 |
| the user's location | mode, and/or genre | is more likely to select content items having a |
| | | mood, mode, and/or loudness that corresponds to |
| | | the weather at the user's location. For example, |
| | | clear, sunny weather may correspond to upbeat, |
| | | major key content items. Cloudy weather may |
| | | correspond to sad, minor key content items. |
| Rate of change of | Mood, mode, | In various embodiments, the playback system 110 |
| the user's | loudness, and/or genre | is more likely to select content items having |
| geographic location | | mood, mode, loudness, and/or genre |
| (e.g., speed) | | corresponding to the user's speed. For example, |
| | | if the user is stationary and/or traveling slowly, |
| | | then slower content items from peaceful genres |
| | | may be selected. Also, for example, if the user is |
| | | traveling very fast, this may be indicated in the |
| | | genre of the selected content items (e.g., outlaw- |
| | | country for users that are in danger of receiving a |
| | | ticket). |
| Time of day | User's listening | In various embodiments, the playback system 110 |
| | history | is more likely to select content items that have |
| | | been previously provided to the user 103 and/or |
| | | similar users at the same time of day. |
| User preferences | Content item identity, | In various embodiments, the playback system 110 |
| (e.g., specific | related parties, genre, | is more likely to select content items that match |
| content items, | etc. | preferences of the user for certain content items, |
| genres, etc.) | | content items in a certain genre, content items |
| | | associated with a particular related party (e.g., |
| | | artist, songwriter, etc.). |
| Day of the week | Mood, mode, | In various embodiments, the playback system 110 |
| | loudness, and/or genre | may consider a day of the week when selecting |
| | | content items. Any suitable criteria may be used. |
| | | For example, the playback system 110 may be |
| | | more likely to select content items that have bee |
| | | previously provided to the user 103 and/or similar |
| | | users on the same day of the week. Also, for |
| | | example, the playback system 110 may select |
| | | active or peppy content on Mondays (e.g., to |
| | | cheer up the user) and celebratory content on |
| | | Fridays. |
| Time of year | Mood, mode, | In various embodiments, the playback system 110 |
| | loudness, and/or genre | may consider a time of year when selecting |
| | | content items. For example, certain content may |
| | | be correlated to different seasons, different |
| | | annual events (e.g., Christmas), etc. |
| Type of activity | Mood, mode, | In some embodiments, the playback system 110 |
| | loudness and/or genre | is programmed to determine a type of the user's |
| | | activity. For example, the at least one sensor 105 |
| | | may sense a tempo or frequency of motion, a |
| | | direction or directions of motion, or combinations |
| | | thereof. The playback system 110 may be |
| | | programmed to relate the output of the at least |
| | | one sensor 105 to a particular type of motion |
| | | (e.g., running, jogging, walking, swimming, |
| | | riding an elliptical machine, using a treadmill, |
| | | etc.). The playback system 110 may be |
| | | programmed to select content items based on the |
| | | detected type of activity. |

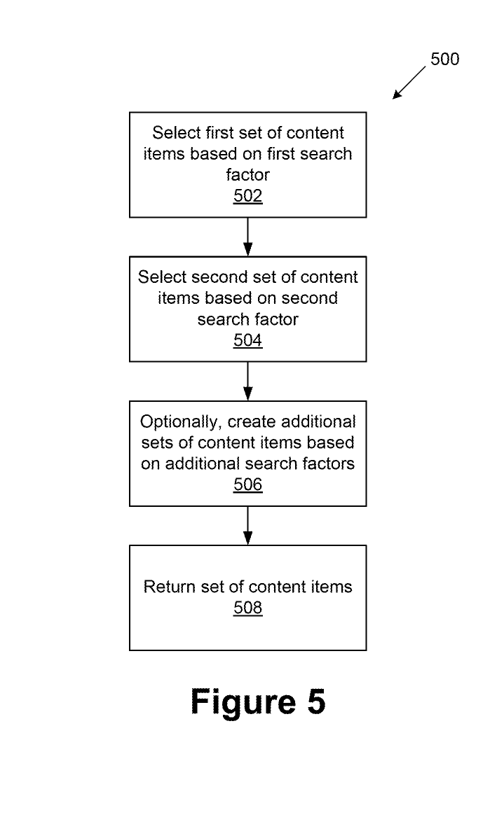

FIG. 5 is a flow chart illustrating one embodiment of a process flow 500 that may be executed by a content provider service (e.g., playback system 110) to select content items in a staged search. For example, the process flow 500 illustrates one suitable manner in which the playback system 110 may select at least one content item at 420 of the process flow 400. Although the process flow 500 is described herein as executed by the playback system 110, it will be appreciated that any suitable component may be used including, for example, another component of the content provider service (e.g., combined system 114), the user device 102, etc. At 502, the playback system 110 may select a first set of content items from a plurality of content items (e.g., a library of content items) based on a first search factor. For example, the playback system 110 may select content items for which at least one content item characteristic corresponding to the first search factor is within a threshold of the first search factor. For example, when the first search factor is user motion tempo, the first set of content items may comprise content items having a tempo within a threshold of the user motion tempo. Also, for example, when the first search factor is a user preference, the value of the threshold may be zero. For example, if the user's preference is to select only content items representing classical music, the first set of content items may comprise only content items representing classical music. Also, for example, if the first search factor is a user's location, and the location correlates to content items having a certain mood, tempo, and/or loudness, then the first set of content items may comprise content items having mood, tempo, and/or loudness that is within a threshold of that called for by the search factor.

At 504, the playback system 110 may select from the first set of content items, a second set of content items. The selection of the second set may be based on a second search parameter. For example, the second set of content items may comprise content items selected from the first set of content items for which one or more content item characteristics corresponding to the second search factor are within a threshold of the second search factor. At 506, one or more additional sets of content items may be generated, for example, by applying a corresponding set of one or more additional search factors. Each application of a search factor may represent a stage. When all search factors have been applied as indicated at 502, 504, and 506, the playback system 110 may return the last-generated set of content items at 508.

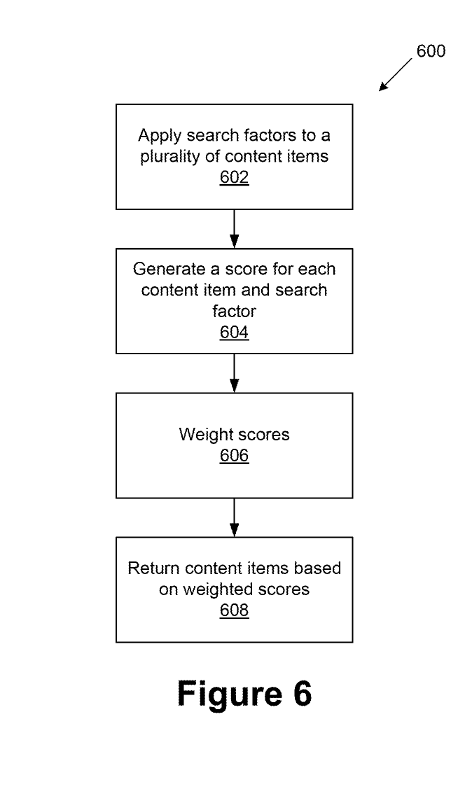

FIG. 6 is flow chart illustrating one embodiment of a process flow 600 that may be executed by a content provider service to select content items utilizing a weighted sum of scores. At 602, the playback system 110 may apply a set of search factors to a plurality of content items. At 604, the playback system 110 may generate a score for each content item and each search factor. For example, the score for a content item and search factor may indicate a degree of correlation between the search factor and the corresponding characteristic of the content item. At 606, the playback system 110 may weigh the scores. Each search factor may have a weight that is applied to the scores for that search factor with respect to all of the content items. The weights for each search factor may be determined in any suitable manner. For example, the playback system 110 may assign higher weights to search factors received and/or requested directly from the user 103. Also, for example, the weights assigned to each factor may be modified based on feedback provided from the user, as described above with respect to 412 and 424. For example, if the user 103 rates a particular selected content item highly or lowly, the weights of the search factors associated with the content item may be appropriately raised and/or lowered.

Upon the weighting of the scores, each content item may be assigned a composite score. The composite score for each content item may be a weighted sum of the individual scores for the content item for each of the search factors. At 608, the playback system 110 may return a set of content items based on the weighted sum of scores. In some embodiments, the playback system 110 may return all content items having weighted sums of scores exceeding a threshold. Also, in some embodiments, the playback system 110 may return a predetermined number of content items having the highest weighted sums of scores.

The features and advantages described in the specification are not all inclusive and, in particular, many additional features and advantages will be apparent to one of ordinary skill in the art in view of the drawings, specification, and claims. The language used in the specification has been principally selected for readability and instructional purposes, and may not have been selected to delineate or circumscribe the disclosed subject matter.

The figures and the following description relate to example embodiments of the invention by way of illustration only. Alternative example embodiments of the structures and methods disclosed here may be employed without departing from the principles of what is claimed.

Any patent, publication, or other disclosure material, in whole or in part, that is said to be incorporated by reference herein is incorporated herein only to the extent that the incorporated materials do not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Reference in the specification to “one example embodiment,” “various example embodiments,” or to “an example embodiment” means that a particular feature, structure, or characteristic described in connection with the example embodiments is included in at least one example embodiment of the invention. The appearances of the phrase “in one example embodiment” or “a preferred example embodiment” in various places in the specification are not necessarily all referring to the same example embodiment. Reference to example embodiments is intended to disclose examples, rather than limit the claimed invention.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of actions (instructions) leading to a desired result. The actions are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times, to refer to certain arrangements of actions requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission, or display devices.

Certain aspects of the present invention include process steps and instructions described herein in the form of a method. It should be noted that the process steps and instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers and computer systems referred to in the specification may include a single processor or may be architectures employing multiple processor designs for increased computing capability.

The methods and displays presented herein are not inherently related to any particular computer or other apparatus. Various general-purpose systems may also be used with programs in accordance with the teachings herein, or it may prove convenient to construct more specialized apparatus to perform the required method actions. The required structure for a variety of these systems will appear from the above description. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been particularly shown and described with reference to a preferred example embodiment and several alternate example embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A computer-implemented system for selecting content for a user, the system comprising:
a computer system comprising at least one processor and operatively associated memory, wherein the computer system is programmed to:
receive from a user device associated with the user a request for a content search;
receive from the user device a first search factor describing motion of the user;
receive a second search factor describing an environment of the user;
select at least one content item to be provided to the user based on at least the first search factor and the second search factor; and
transmit an indication of the at least one content item towards the user device.

2. The system of claim 1, wherein the computer system is further programmed to initiate a provision of the at least one content item to the user device.

3. The system of claim 1, wherein the computer system is further programmed to receive a third search factor describing a content item preference of the user, and wherein the selecting is also based on the third search factor.

4. The system of claim 1, wherein the computer system is further programmed to receive a temporal search factor describing the user and wherein the selected is also based on the temporal search factor.

5. The system of claim 1, wherein selecting the at least one content item to be provided to the user based on the first search factor and the second search factor comprises:
for each of a plurality of content items, comparing the first search factor to at least one content item characteristic corresponding to the first search factor; and
for each of the plurality of content items, comparing the second search factor to at least one content item characteristic corresponding to the second search factor.

6. The system of claim 5, wherein the first search factor is a tempo of the motion of the user and wherein the content item characteristic corresponding to the first search factor is a content item tempo.

7. The system of claim 5, wherein the second search factor is a geographic location of the user, and wherein the at least one content item characteristic corresponding to the second search factor comprises a mood.

8. The system of claim 5, wherein the second search factor is a weather condition at a geographic location of the user, and wherein the at least one content item characteristic corresponding to the second search factor comprises a content item mood.

9. The system of claim 5, wherein the selecting of the at least one content item to be provided to the user based on the first search factor and the second search factor comprises:
selecting a first set of content items, wherein the first set of content items consists of content items selected from the plurality of content items for which the at least one content item characteristic corresponding to the first search factor is within a threshold of the first search factor; and
selecting a second set of content items, wherein the second set of content items consists of content items selected from the first set of content items for which the at least one content item characteristic corresponding to the second search factor is within a threshold of the second search factor.

10. The system of claim 9, wherein the selecting of the at least one content item to be provided to the user based on the first search factor and the second search factor further comprises:
selecting a third set of content items, wherein the third set of content items consists of content items selected from the second set of content items, and wherein the third set of content items comprises content items for which at least one characteristic corresponding to a third search describing a content item preference of the user meets the third search factor.

11. The system of claim 5, wherein the selecting of the at least one content item to be provided to the user based on the first search factor and the second search factor comprises:
assigning a first score to each of the plurality of content items, wherein the first score for each of the plurality of content items indicates a correlation between the first search factor and the at least one content item characteristic for the content item corresponding to the first search factor;
assigning a second score to each of the plurality of content items, wherein the second score for each of the plurality of content items indicates a correlation between the second search factor and the at least one content item characteristic for the content item corresponding to the second search factor; and
calculating a weighted sum of the first score and the second score, wherein calculating the weighted sum comprises assigning the first score a first weight and the second score a second weight.

12. The system of claim 11, wherein the selecting of the at least one content item to be provided to the user based on the first search factor and the second search factor further comprises:
assigning a third score to each of the plurality of content items, wherein the third score, for each of the plurality of content items, indicates a correlation between a third search factor and at least one content item characteristic for the content item corresponding to the third search factor; and
wherein the weighted sum is also of the third score.

13. The system of claim 11, wherein the computer system is further programmed to:
receive from the user a rating of the at least one content item transmitted towards the user device; and
modify at least one of the first weight and the second weight based on the rating.

14. The system of claim 1, wherein the computer system is further programmed to:
receive from the user a rating of the at least one content item transmitted towards the user device; and
modify at least one parameter of the selecting based on the rating.

15. A computer-implemented system for selecting content for a user, the system comprising:
a computer system comprising at least one processor and operatively associated memory, wherein the computer system is programmed to:
receive from a user device associated with the user a request for a content search;
receive, from the user device a first search factor describing motion of the user;
receive a temporal search factor describing the user;
select at least one content item to be provided to the user based on at least the first search factor and the temporal search factor; and
transmit an indication of the at least one content item towards the user device.

16. A computer-implemented method for selecting content for a user, the method comprising:
receiving, by a computer system and from a user device associated with the user, a request for a content search, wherein the computer system comprises at least one processor and operatively associated memory;
receiving, by the computer system and from the user device a first search factor describing motion of the user;
receiving, by the computer system, a second search factor describing an environment of the user;
selecting, by the computer system, at least one content item to be provided to the user based on at least the first search factor and the second search factor; and
transmitting an indication of the at least one content item towards the user device.

17. The method of claim 16, further comprising receiving, by the computer system, a temporal search factor describing the user and wherein the selected is also based on the temporal search factor.

18. The method of claim 16, further comprising receiving a third search factor describing a content item preference of the user, and wherein the selecting is also based on the third search factor.

19. The method of claim 16, wherein selecting the at least one content item to be provided to the user based on the first search factor and the second search factor comprises:
for each of a plurality of content items, comparing the first search factor to at least one content item characteristic corresponding to the first search factor; and
for each of the plurality of content items, comparing the second search factor to at least one content item characteristic corresponding to the second search factor.

20. The method of claim 16, wherein the first search factor is a tempo of the motion of the user and wherein the content item characteristic corresponding to the first search factor is a content item tempo.

21. The method of claim 16, wherein the second search factor is a geographic location of the user, and wherein the at least one content item characteristic corresponding to the second search factor comprises a mood.

22. The method of claim 16, wherein the selecting of the at least one content item to be provided to the user based on the first search factor and the second search factor comprises:
selecting a first set of content items, wherein the first set of content items consists of content items selected from the plurality of content items for which the at least one content item characteristic corresponding to the first search factor is within a threshold of the first search factor; and
selecting a second set of content items, wherein the second set of content items consists of content items selected from the first set of content items for which the at least one content item characteristic corresponding to the second search factor is within a threshold of the second search factor.

23. The method of claim 16, wherein the selecting of the at least one content item to be provided to the user based on the first search factor and the second search factor comprises:
assigning a first score to each of the plurality of content items, wherein the first score for each of the plurality of content items indicates a correlation between the first search factor and the at least one content item characteristic for the content item corresponding to the first search factor;
assigning a second score to each of the plurality of content items, wherein the second score for each of the plurality of content items indicates a correlation between the second search factor and the at least one content item characteristic for the content item corresponding to the second search factor; and
calculating a weighted sum of the first score and the second score, wherein calculating the weighted sum comprises assigning the first score a first weight and the second score a second weight.

24. A computer-implemented method for selecting content for a user, the method comprising:
receiving, by a computer system and from a user device associated with the user, a request for a content search, wherein the computer system comprises at least one processor and operatively associated memory;
receiving, by the computer system and from the user device a first search factor describing motion of the user;
receiving, by the computer system, a temporal search factor describing the user;
selecting, by the computer system, at least one content item to be provided to the user based on at least the first search factor and the second search factor; and
transmitting an indication of the at least one content item towards the user device.
